(19) United States
(12) Patent Application Publication
(10) Pub. No.: US 2026/0273689 A1
(43) Pub. Date: Sep. 17, 2026

(54) FLAT GRINDING MACHINE WITH LASER POSITION MEASUREMENT IN THE LONGITUDINAL AXIS

(71) Applicant: ZIERSCH GMBH, Ilmenau (DE)

(72) Inventor: Frank ZIERSCH, La Neuveville (CH)

(21) Appl. No.: 19/163,169

(22) PCT Filed: Mar. 1, 2024
(86) PCT No.: PCT/EP2024/055386

§ 371 Date: Sep. 8, 2025

(30) Foreign Application Priority Data
Mar. 8, 2023 (DE) 10 2023 105 728.6

(51) Int. Cl. B24B 49/12; B23Q 17/24; B24B 7/02; B24B 41/02; B24B 57/00

(52) U.S. Cl. CPC B24B 49/12; B23Q 17/2428; B24B 7/02; B24B 41/02; B24B 57/00

(57) ABSTRACT

A flat grinding machine comprises a machine frame having a machine bed with a guide shaft extending in an X-direction. The machine also has a workpiece table movable back and forth in the guide shaft. The upwardly directed opening of the guide shaft is covered by a cover adjacent to each side of the workpiece table. A grinding wheel is positioned above the workpiece table and can be vertically adjusted in a Z-direction. In the guide shaft below the cover, a length measurement assembly is attached which comprises a laser radiation source and a laser radiation sensor. On the workpiece table below the level of the cover, a reflector is attached which reflects the laser radiation emitted from the laser radiation source in the guide shaft to the laser radiation sensor. The length measurement assembly determines the position of the workpiece table from the transit time of the laser radiation.

### BACKGROUND OF THE INVENTION

The invention relates to a flat grinding machine comprising a machine frame, a workpiece table which can be moved back and forth in an X-direction and a rotatable grinding wheel which can be displaced in a Z-direction.

Grinding machines have been used for decades to machine a wide variety of workpieces and surfaces. There are several designs of grinding machines, whose moving axes and machine tables are adapted to the specific grinding tasks.

DE 22 55 724 A discloses a device for controlling a reciprocating machine tool carriage, which is used in particular in a so-called flat grinding machine. The control device acts on a grinding carriage of the machine and has a hydraulic pressure supply, a proportional solenoid valve connected to this pressure supply and an actuating cylinder for positioning the carriage, which is connected to the solenoid valve output. Furthermore, means for determining the carriage position and speed as well as means for presetting the stroke amplitude and speed of the carriage are provided. Electronic measuring circuits are controlled by the means for determining and presetting such that they can be used to control the opening of the solenoid valve depending on the positioning error and the speed deviation of the carriage.

DE 26 45 074 A1 describes a flat grinding machine comprising a table designed to hold workpieces and which can be moved back and forth relative to a head carrying the grinding wheel by means of a drive. The drive comprises a toothed belt fastened to the table at its ends. In one embodiment of this machine, the drive has a thyristor amplifier and three limit switches, two of which serve as absolute travel limits for the table, and the third is located approximately in the middle of the travel path of the table. A contact cam is fastened to the table to actuate the three limit switches.

DE 30 41 491 C2 describes a reversing means for the hydraulic drive of a workpiece table which can be moved within the machine bed of a flat grinding machine. The table is coupled to a double-acting hydraulic cylinder and is operatively connected to a switch fastened to the machine bed. A reversing valve, actuated by a hydraulic pump, is connected to the hydraulic cylinder via hydraulic lines and controlled by an electronic controller. Non-contact switches are arranged in the center of the machine bed.

EP 0 614 724 A2 discloses a machine tool comprising a machine frame, a workpiece carrier arranged on the machine frame for a workpiece to be machined, a tool carrier arranged on the machine frame for receiving a tool and at least one drive with a carriage for performing a relative movement between the tool and the workpiece. The drive has two electric linear motors aligned parallel to the axis and spaced apart in a transverse direction. The carriage extends between the two linear motors. A controller controls the linear motors simultaneously to move the carriage.

CN 217 143 434 U describes a high-speed machining center for grinding knife tips. The high-speed machining center has a lathe bed, a workpiece sliding table, a workpiece main shaft, a workpiece spindle drive unit, a grinding unit and a laser measuring unit.

DE 10 2012 212 333 A1 describes a method and device for determining a thickness measurement of a polishing pad of a polishing machine.

Flat grinding machines currently in use have long used two or more limit switches, the position of which is adjustable in the X-direction, to limit and control the movement of the workpiece table along its longitudinal axis (X-direction). Since the accuracy requirements for the reciprocating movement of the table are low, expensive glass scales, such as those used to control the movement of the grinding wheel in the Z-direction, are not required. However, the limit switches used instead have the disadvantage that they can require a great deal of maintenance and cleaning, as large quantities of chips and coolant are generated during the grinding process. Furthermore, there is a high risk for the machine operator if the operator attempts to reposition the limit switches during an ongoing grinding process, as their actuating heads are frequently located within the range of movement of the sometimes rapidly moving workpiece table. Finally, there is often a lack of direct integration of the table movement control into the central control unit of the machine, which, for example, controls the grinding wheel feed.

### SUMMARY OF THE INVENTION

One object of the invention, proceeding from the prior art, is to provide an improved flat grinding machine which allows precise, low-maintenance, safe and simple detection and adjustment of the movement of the workpiece table in the X-direction.

This object is achieved by a flat grinding machine according to the appended claim 1.

The flat grinding machine according to the invention firstly has a machine frame which has a machine bed with a guide shaft extending in an X-direction. Furthermore, a movable workpiece table is provided, which is driven by a table drive and can be moved back and forth in the X-direction in the guide shaft of the machine bed. An upwardly directed opening of the guide shaft, in which a lower part of the workpiece table can be moved in the X-direction, is covered by a cover adjacent to each side of the workpiece table. The cover closes the upper opening of the guide shaft, preventing dirt or other debris from entering and also avoiding the risk of reaching in during the grinding process. At the same time, the cover is designed so that the movement of the workpiece table in the X-direction is not hindered. The cover preferably also effectively shields the guide shaft from ambient light.

The flat grinding machine further comprises at least one rotatable grinding wheel which is positioned above the workpiece table and can be at least vertically adjusted in a Z-direction extending perpendicularly to the X-direction in order to grind a workpiece clamped on the workpiece table.

Finally, the flat grinding machine has a length measurement assembly which is attached to the machine frame in the guide shaft below the level of the cover. This length measurement assembly comprises a laser radiation source and a laser radiation sensor. On the movable workpiece table below the level of the cover, a reflector is also attached which reflects the laser radiation emitted from the laser radiation source into the guide shaft back to the laser radiation sensor. The length measurement assembly uses an integrated or associated processor unit (which can also be located in a separate housing) to determine the position of the workpiece table in the X-direction from the transit time of the emitted laser radiation, namely on the way from the laser radiation source to the reflector and from there back to the laser radiation sensor. The laser radiation thus travels twice between the length measurement assembly and the reflector, which must be taken into account when determining the position of the workpiece table.

A significant advantage of the flat grinding machine according to the invention is that manually positioned limit switches can be completely dispensed with. During machining of a workpiece, the current position of the workpiece table can be continuously determined and used to control the movement of the table in the X-direction. A standalone control unit or, preferably, a central control unit of the flat grinding machine can be used for this purpose. Eliminating conventional limit switches eliminates a high risk of injury for the machine operator, as there is no longer any need to reach into the range of movement of the table. Maintenance effort is also reduced, as the limit switches no longer become dirty and numerous smaller openings from which, for example, coolant can escape are no longer required. Instead, the machine bed can be designed as a tray that is substantially closed at the bottom.

A significant additional advantage is that the current position of the workpiece table can now be recorded very precisely at any time. This not only eliminates the need to reverse the direction of the linear movement of the table between two end positions, but also makes it possible to change the path of the pendulum movement during machining of a workpiece without having to interrupt the machining process. This shortens the overall machining time and allows for new methods of workpiece machining with variable movement distances in the X-direction. Preferably, the position signal generated by the length measurement assembly is fed into the central control unit of the machine so that all control and adjustment options of the machine are now centrally consolidated.

The arrangement of the entire length measurement assembly below the cover provides excellent protection against contamination and prevents the penetration of ambient light, thus preventing measurement interference.

The machine frame preferably comprises a plurality of cast metal machine components. This results in a high machine weight and high rigidity, which has a positive effect on the achievable machining accuracy.

According to an advantageous embodiment, the cover of the guide shaft is formed by bellows or plates that can be moved relative to one another. This ensures good protection against contamination and simultaneously allows quick access to the guide shaft if cleaning or maintenance work is required.

A further developed embodiment is characterized in that the grinding wheel rotates about a rotation axis extending in a Y-direction perpendicular to the X-direction and perpendicular to the Z-direction, with the grinding wheel preferably being displaceable in this Y-direction. The ability to move the grinding wheel along two axes increases the application possibilities of the flat grinding machine. Preferably, the displacements along the Z-axis and the Y-axis are realized by preloaded linear guide systems which allow high precision.

The guide shaft in the machine bed provides the space for the movement of the workpiece table in the X-direction. The table is preferably guided by scraped and coated sliding guides extending in the X-direction. This ensures excellent damping properties and a high-quality surface finish on the workpiece. The table drive is preferably designed as a hydraulic drive, with multiple hydraulic cylinders coupled to the workpiece table. The hydraulic drive for the longitudinal movement of the workpiece table is particularly preferably equipped with a cooling unit. Instead, the transverse and vertical movements of the grinding wheel (in the Y-direction and Z-direction) are preferably realized by electric motor or electromagnetic drives.

In a particularly preferred embodiment, the laser radiation source and the laser radiation sensor are accommodated in a common housing, which is attached in the region of the guide shaft on the machine bed under the cover. The source and the sensor are thus located in close proximity to one another and are fastened to a part of the machine frame where only minimal vibrations and shocks occur, which increases the functional reliability of the entire assembly.

It is advantageous if the length measurement assembly comprises a processor unit which controls the laser radiation source, receives a sensor signal from the laser radiation sensor and determines the position of the workpiece table in the X-direction from the transit time of the emitted laser radiation. A prefabricated laser length measurement unit is particularly preferably used as the length measurement assembly. This unit requires only a few electrical cables for connection, which only need to be laid on non-moving parts of the machine.

A suitable embodiment comprises a dressing unit mounted on the workpiece table. The length measurement assembly provided according to the invention allows the workpiece table to be precisely positioned not only in its end positions but also across its entire range of movement in the X-direction. This allows simple and quick positioning of the dressing unit, which can further shorten machining times and ensure high accuracy when dressing the grinding wheel.

### BRIEF DESCRIPTION OF THE DRAWINGS

Further advantages and details of the invention are apparent from the following description of a preferred embodiment, with reference to the drawing in which:

FIG. 1 is a simplified front view of a flat grinding machine according to the invention;

FIG. 2 is a view from above into a guide shaft of a machine bed of the flat grinding machine according to FIG. 1; and

FIG. 3 is a perspective view of a workpiece table and a length measurement assembly.

### DETAILED DESCRIPTION OF THE INVENTION

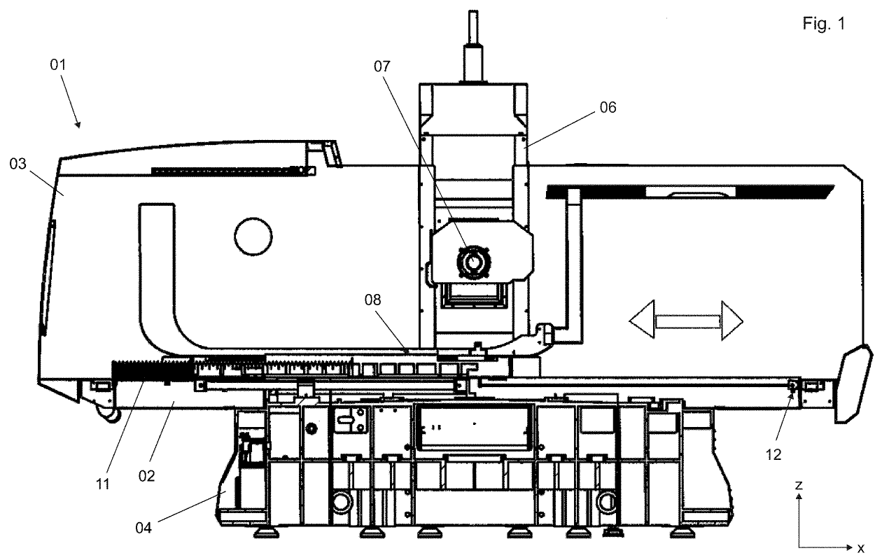

FIG. 1 shows an exemplary embodiment of a flat grinding machine according to the invention in an overall front view, without any details. The flat grinding machine has a machine frame 01, which comprises a machine bed 02, a machine housing 03 and a machine base 04. The machine bed 02 extends longitudinally in an X-direction. A grinding wheel 07 is attached to a column support 06 and can be moved at least in a Z-direction, preferably also in a Y-direction, perpendicular to the X-direction.

A workpiece table 08 can be moved back and forth in the X-direction (symbolized by a double arrow), driven by a hydraulic table drive (not shown). The top of the workpiece table, on which a workpiece can be clamped, faces the grinding wheel 07. The lower part of the table 08, including guide and drive elements, is positioned in a guide shaft 09 extending into the machine bed 02. The upwardly directed opening of the guide shaft 09 is covered by a cover, here a bellows 11, adjacent to each side of the workpiece table 08. The movement of the workpiece table 08 in the X-direction is not hindered by the bellows 11. The guide shaft is thus protected against the ingress of dirt from above by the workpiece table and the bellows. Furthermore, the bellows, made of opaque material, prevents any or very little ambient light from penetrating the guide shaft 09, so that measurement with the laser beam is not hindered.

A length measurement assembly 12 is attached to the machine frame 01, specifically in the guide shaft 09, below the level of the cover formed by the bellows 11. The length measurement assembly 12 comprises a laser radiation source and a laser radiation sensor or detector, which are located in a common housing that is attached to the machine frame, for example, screwed in place with adjustment means. On the workpiece table 08 below the level of the cover 11, a reflector 13 (FIG. 2) is also attached which reflects the laser radiation emitted from the laser radiation source and running in the guide shaft back to the laser radiation sensor. The length measurement assembly 12 or a processor unit associated therewith determines, in a conventional manner, the position of the workpiece table in the X-direction relative to the machine frame and thus relative to the grinding wheel 07 from the transit time of the emitted laser radiation, starting from the source via the reflector back to the sensor.

FIG. 2 is a view from above into the guide shaft 09. The drawing plane has been selected so that the reflector 13 attached on the workpiece table, which protrudes into the guide shaft from above, remains visible. In the operating mode of the machine, a laser beam 14 passes between the length measurement assembly 12 attached to the machine frame and the reflector 13 in order to measure the distance between these two elements, from which the position of the workpiece table can be determined.

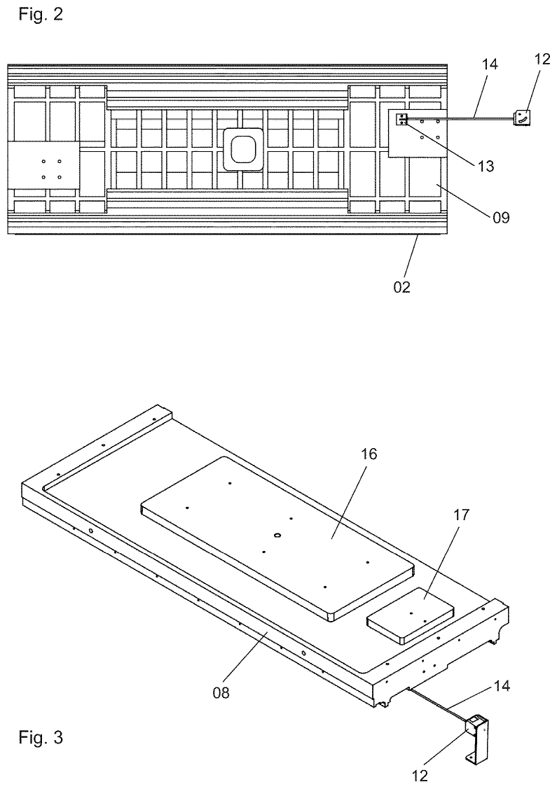

FIG. 3 shows the workpiece table 08 in a perspective view. The length measurement assembly 12 is also shown, but not the machine frame to which this assembly is attached. It can be seen that the laser beam 14 runs parallel to the workpiece table 08, namely in the X-direction in which the workpiece table is movable. A workpiece 16 is clamped on the workpiece table for machining. In this embodiment, the workpiece table 08 also supports a dressing unit 17.

1.-10. (canceled)

11. A surface grinding machine including:
a machine frame, which includes a machine bed with a guiding bay extending in an x-direction;
a workpiece table, which is driven by a table drive and which can be moved back and forth in the guiding bay in the x-direction;
a rotatable grinding wheel, which is positioned above the workpiece table and which is height-adjustable at least in a z-direction perpendicular to the x-direction in order to grind a workpiece clamped on the workpiece table;
characterized in that the upwards facing opening of the guiding bay is respectively covered on the sides bordering the workpiece table by a cover that allows the movement of the workpiece table, in that a length measurement unit is mounted on the machine frame in the guiding bay below the plane of the cover, which length measurement unit includes a laser radiation source and a laser radiation sensor, and in that a reflector is mounted on the workpiece table, likewise below the plane of the cover, which reflects the laser radiation emitted by the laser radiation source in the guiding bay to the laser radiation sensor, wherein the length measurement unit includes a processor unit which controls the laser radiation source, which receives a sensor signal from the laser radiation sensor, and which determines the position of the workpiece table in the x-direction from the transit time of the emitted laser radiation and provides said position for the control of the movement of the workpiece table in the x-direction.

12. The surface grinding machine according to claim 11, wherein the cover of the guiding bay is formed by one or more bellows or by plates that can be moved relative to one another.

13. The surface grinding machine according to claim 11, wherein the grinding wheel rotates about an axis of rotation that extends in a y-direction perpendicular to the x-direction and perpendicular to the z-direction, wherein the grinding wheel can also be moved in this y-direction.

14. The surface grinding machine according to claim 11, wherein the laser radiation source and the laser radiation sensor are accommodated in a common housing, which is mounted in the guiding bay on the machine bed.

15. The surface grinding machine according to claim 11, wherein the processor unit supplies the determined position in the form of a table position signal to a central control unit of the surface grinding machine.

16. The surface grinding machine according to claim 15, wherein the central control unit controls the movement of the workpiece table in the x-direction.

17. The surface grinding machine according to claim 11, wherein the table drive is formed by a plurality of hydraulic cylinders coupled to the workpiece table.

18. The surface grinding machine according to claim 11, wherein the workpiece table is guided in sliding guides in the x-direction.

19. The surface grinding machine according to claim 11, wherein the workpiece table carries a dressing unit for dressing the grinding wheel.

20. The surface grinding machine according to claim 12, wherein the one or more bellows forming the cover are made of a material that is impervious to light.
